(19) United States
(12) Patent Application Publication
(10) Pub. No.: US 2008/0125567 A1
(43) Pub. Date: May 29, 2008

(54) COMPOSITION AND METHOD FOR ENHANCEMENT OF ACID VALUE OF POLYESTERS

(76) Inventors: Deepak Ramaraju, Bangalore (IN); Gomatam Raghavan Ravi, Bangalore (IN); Gaurav Mediratta, Bangalore (IN); Govind Subbanna Wagle, Bangalore (IN)

Correspondence Address: SABIC - O8CV - CPP;SABIC Innovative Plastics - IP Legal, ONE PLASTICS AVENUE, PITTSFIELD, MA, 01201-3697, US

(21) Appl. No.: 11/564,074

(22) Filed: Nov. 28, 2006

(51) Int. Cl. C08G 63/16

(52) U.S. Cl. 528/302

(57) ABSTRACT

A composition of matter comprising an acid terminated polyester composition containing: (a) a polyester derived from at least one diol selected from the group consisting of ethylene glycol; propylene glycol, butanediol, xylene glycol, and a first diacid component; and (b) a second diacid component; and wherein the composition contains a residual of the second diacid component that is at least less than about 1000 parts per million is disclosed. Also disclosed is a process to prepare these compositions and articles therefrom.

### BACKGROUND OF THE INVENTION

This invention relates to a polyester composition.

Polyesters are made by reaction of a diol with a dicarboxylic acid or a diester. For instance, polybutylene terephthalate is made by the reaction of 1,4-butanediol (BDO) with terephthalic acid (TPA) or dimethylterephthalate (DMT). Typically, the butanediol is taken in a molar excess over the acid, which leads to the polybutylene terephthalate primarily containing hydroxyl end groups and a small percentage, usually below 20%, of acid end groups (also hereinafter known as “carboxyl end groups or CEG”). Apart from the hydroxyl end groups, the polyester formed may also contain ester end groups, especially when a diester is used for the synthesis of the polyester, e.g., dimethylterephthalate in the case of polybutylene terephthalate. The acid end groups, as a percentage of total end groups are typically below 50-55% for most commercial polyesters as too much dicarboxylic acid affected the physical properties of polyester.

Preparation of polyesters with enhanced acid value by starting directly from the reaction of monomers is known in the art. A one-step process for the preparation of carboxyl group-terminated polyesters suitable for use in powdered thermosetting coating compositions is disclosed in GB Pat. No. 2,189,498. In another Japanese Pat. Application JP 5,514,5731A a process for making polyethylene terephthalate (PET) is disclosed, wherein the process involves first, esterifying terephthalic acid (hereinafter also known as “TPA”) and ethylene glycol (hereinafter also known as “EG”) to make a low molecular weight polymer which is subsequently polycondensed using an antimony or germanium catalyst to obtain the polyester with greater than 80% carboxyl end group. This type of process when applied to polybutylene terephthalate, generates substantial amount of tetrahydrofuran as an undesirable side product and generally high acid value for polybutylene terephthalate is less common.

One of the approaches to increase acid value of polyesters is illustrated by the reaction of hydroxyl end groups of polyesters with carboxylic anhydrides. U.S. Pat. Nos. 5,439,988; 6,342,578; WO 02/066541A, and US. Pat Application No. 2005/0176920 disclose the reaction of various anhydrides with hydroxyl end groups of polyester chains to generate high acid value polyesters through the ring-opening of anhydride molecules. Anhydride molecules have two carboxy groups adjacent to each other contrary to the para geometric disposition in 1,4-dicarboxylic acid molecules such as para-terephthalic acid used in semicrystalline polyesters such as PBT. Incorporation of anhydrides affects the linearity of polymer structure such as in PBT where crystallinity depends on the structural integrity. However, this approach suffers from the limitation that the anhydrides used have a tendency to volatilize at the temperatures required for the reaction.

Another approach to increase acid value of polyesters is by carrying out transesterification reactions between polyester and diacid monomers as disclosed in U.S. Pat. No. 4,085,159. This patent publication teaches a composition for a powder coating wherein the process for making the composition involves three steps. The first step is the formation of a branched polyester; the second step involves reacting the high hydroxyl polyesters with dicarboxylic acids such as isophthalic acid or terephthalic acid to make a high acid polyester resin. The third step involves mixing of the above high acid polyester with polyfunctional epoxides to give a powder that can be cured at high temperatures to give a thermosetting network for coating applications. The second step disclosed in this patent preferentially uses several fold excess of acid monomer as compared to stoichiometric requirement and hence represents an inefficient process for high acid polyester thermoplastics. U.S. Pat. No. 5,017,679 discloses the use of 1,3-cyclohexane dicarboxylic acid or 1,4-cyclohexane dicarboxylic acid modifiers in stoichiometric quantities for reaction with the hydroxyl end groups of a neopentyl glycol based polyester to make predominantly acid end groups. It is disclosed that the high acid polyesters made by this process possess significantly higher Tg than a polyester formed directly from hydroxylic and acid monomers including cyclohexane dicarboxylic monomer required for acid enhancement. This process is specific to neopentyl glycol polyesters for powder coating and does not describe the amount of unreacted monomeric acid that could be left in the reaction mixture after acid enhancement of polymer.

Yet another approach for high acid polyesters is as disclosed in the U.S. Pat. No. 6,232,435, which teaches the preparation of a high acid polyester through aeration of polyester with oxygen containing gas over a long period (overnight), followed by heating. The amount of hydroxyl end groups that disappeared in the reaction was not proportionate to the amount of acid groups formed in the oxidation step.

For the foregoing reasons, there is a is a continued need to come up with an improved method that increases the polyester carboxyl end groups without any undesirable side reactions such as chain scission and generation of undesirable end groups like vinyl end groups and unravel hitherto unknown advantages of highly acid enhanced polyester systems.

### BRIEF DESCRIPTION OF THE INVENTION

According to one embodiment of the present invention, the invention relates to a composition of matter comprising an acid terminated composition containing:

a. a polyester derived from at least one diol selected from the group consisting of ethylene glycol; propylene glycol, butanediol, xylene glycol, and a first diacid component; and

b. a second diacid component; and

wherein the composition contains a residual of the second diacid component that is at least less than about 1000 parts per million.

In another embodiment, the invention relates to a process comprising

i. mixing a hydroxyl terminated polyester having end groups, wherein the hydroxyl terminated polyester is derived from at least one diol selected from the group consisting of ethylene glycol; propylene glycol, butanediol, xylene glycol, and a first diacid and comprising at least about 10 percent of hydroxyl end groups relative to the total number of end groups and a second diacid to form a first mixture;

ii. heating the first mixture at a temperature in the range from about 170 to about 280° C., wherein the heating is carried out at a pressure in the range from about 100 milli bar to about 900 mili bar to form a composition of matter comprising an acid terminated polyester composition containing (a) a polyester derived from at least one diol selected from the group consisting of ethylene glycol; propylene glycol, butanediol, xylene glycol, and a first diacid component; and (b) a second diacid component; and wherein the composition contains a residual of the second diacid component that is at least less than about 1000 parts per million.

In another embodiment, the invention relates to an article molded from such a composition.

And in another embodiment, the invention relates to a composition of matter comprising an acid terminated polyester composition containing:

a. a polyester derived from at least one diol selected from the group consisting of ethylene glycol; propylene glycol, butanediol, xylene glycol, and a first diacid component; and

b. a second diacid component; and

wherein the amount of a residual second diacid is at least less than about 1000 parts per million; and wherein the polyester has greater than about 80 percent acid end groups relative to the total number of end groups, and less than about 10 percent of a vinyl terminated polyester relative to the total number of end groups.

Various other features, aspects, and advantages of the present invention will become more apparent with reference to the following description, examples, and appended claims.

### DETAILED DESCRIPTION OF THE INVENTION

In one embodiment the invention is based on the discovery that heating a hydroxyl terminated polyesters with diacids overcomes the volatility problems experienced using acid anhydrides. The process is carried out under vacuum to give a polyester composition with high percent of acid end groups thus overcoming the degradation problems observed using diacids at high temperature and atmospheric pressure. The polyester composition prepared from this process is essentially free from the unreacted diacid.

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values inclusive of the minimum and maximum values. Unless expressly indicated otherwise, the various numerical ranges specified in this application are approximations.

As used herein, the term “aliphatic radical” refers to a radical having a valence of at least one comprising a linear or branched array of atoms, which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, an aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n =2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂—)₄—. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph-), bromopropylphenyl (i.e. BrCH₂CH₂CH₂Ph-), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh-), aminocarbonylphenyl (i.e. NH₂COPh-), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph-), 4-mercaptomethylphemyl (i.e. 4-HSCH₂Ph-), 4-methylthiophenyl (i.e. 4-CH₃SPh-), methoxyphenyl, methoxycarbonylphenyloxy (e.g. methyl salicyl), nitromethylphenyl (i.e.-PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈-) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical, which comprises at least one substituent. A substituted cycloaliphatic radical may comprise as many substituents as there are positions available on the cycloaliphatic radical for substitution. Substituents that may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e.—OC₆H₁₁C(CF₃)₂C₆H₁₁O—), chloromethylcyclohexyl; 3-trifluorovinyl-2-cyclopropyl; 3-trichloromethylcyclohexyl (i.e. 3-CCl₃C₆H₁₁-), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁-), aminocarbonylcyclopenyl (i.e. NH₂COC₅H₉—), 4-acetyloxycyclohexyl, dicyanoisopropylidenebis(4-cyclohexyloxy) (i.e.—OC₆H₁₁C(CN)₂C₆H₁₁O—), 3-methylcyclohexyl, methylenebis(4-cyclohexyloxy) (i.e.—OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e.—OC₆H₁₁(CH₂)₆ C₆H₁₁O—); 4-hydroxymethylcyclohexyl (i.e. 4-HOCH₂C₆H₁₁-), 4-mercaptomethylcyclohexyl (i.e. 4-HSCH₂C₆H₁₁—), 4-methylthiocyclohexyl (i.e. 4-CH₃SC₆H₁₁O—), 4-methoxycyclohexyl, 2-methoxycarbonylcyclohexyloxy(2-CH₃OCO C₆H₁₁O—), nitromethylcyclohexyl (i.e. NO₂CH₂C₆H₁₀—), trimethylsilylcyclohexyl, t-butyldimethylsilylcyclopentyl, 4-trimethoxysilyethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl(C₄H₇O—) represents a C₄ cycloaliphatic radical. The cyclohexylmethyl radical (C₆H₁₁CH₂—) represents a C₇ cycloaliphatic radical.

According to one embodiment of the invention relates to a composition of matter comprising an acid terminated polyester composition containing:

a. a polyester derived from at least one diol selected from the group consisting of ethylene glycol; propylene glycol, butanediol, xylene glycol, and a first diacid component; and

b. a second diacid component; and

wherein the composition contains a residual of the second diacid component that is at least less than about 1000 parts per million.

Typically polyester resins are typically obtained through the condensation or ester interchange polymerization of the diol or diol equivalent component with the diacid or diacid chemical equivalent component. In one embodiment the polyester resins include crystalline polyester resins such as polyester resins derived from at least one diol selected from the group consisting of ethylene glycol, propylene glycol, butanediol, xylene glycol, and at least one dicarboxylic acid. Preferred polyesters have repeating units according to structural formula (I)

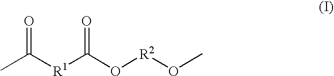

wherein, R¹ and R² are independently at each occurrence a aliphatic, aromatic and cycloaliphatic radical. In one embodiment, R² is an alkyl radical compromising a dehydroxylated residue derived from an aliphatic or cycloaliphatic diol, or mixtures thereof, containing from 2 to about 20 carbon atoms and R¹ is an aromatic radical comprising a decarboxylated residue derived from an aromatic dicarboxylic acid. The polyester is a condensation product where R² is the residue of an aromatic, aliphatic or cycloaliphatic radical containing diol in particular ethylene glycol, propylene glycol, butanediol, xylene glycol or chemical equivalent thereof, and R¹ is the decarboxylated residue derived from an aromatic, aliphatic or cycloaliphatic radical containing diacid of C₁ to C₃₀ carbon atoms or chemical equivalent thereof.

In one embodiment, the dicarboxylic acid is obtained from a first diacid component. The first diacid includes carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, stilbene dicarboxylic acid, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, aliphatic esters, e.g., dialiphatic esters, diaromatic esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, stilbene dicarboxylic acids, naphthalene dicarboxylic acids, and the like, and mixtures comprising at least one of the foregoing dicarboxylic acids.

Examples of these polyvalent carboxylic acids include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxylic acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

In a preferred embodiment the first diacid is selected from the group consisting of, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof. In yet another embodiment the second diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

In one embodiment, the diol is at least one selected from the group consisting of ethylene glycol; propylene glycol, butanediol, xylene glycol and chemical equivalents of the same. Chemical equivalents to the diols include esters, such as dialkylesters, diaryl esters, and the like. In another embodiment there may be optionally present additional diols, which may be straight chain, branched, or cycloaliphatic diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4-butanediol, hexamethylene glycol, xylene glycol, decamethylene glycol, 1,4-cyclohexane dimethanol, or neopentylene glycol.

In yet another embodiment, the additional diols may include polyvalent alcohols that include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, p-xylene glycol, 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like.

In one embodiment, the polyesters of the present invention may be a polyether ester block copolymer including, a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof, and at least one poly(alkylene oxide) glycol selected from: polyethylene glycol or poly(1,2- and 1,3-propylene oxide) glycol with an average molecular weight of about 400-5000, ethylene oxide-propylene oxide copolymer, and ethylene oxide-tetrahydrofuran copolymer.

The polyester can be present in the composition at about 1 to about 99 weight percent, based on the total weight of the composition. The preferred polyesters preferably have an intrinsic viscosity (as measured in 60:40 solvent mixture of phenol/tetrachloroethane at 25° C.) ranging from about 0.1 to about 1.5 deciliters per gram. Polyesters branched or unbranched generally will have a weight average molecular weight of from about 5,000 to about 150,000, preferably from about 8,000 to about 95,000 as measured by gel permeation chromatography using 95:5 weight percent of chloroform to hexafluoroisopropanol mixture.

In one embodiment the polyester comprises a second diacid component. The second diacid component. Non-limiting examples of second diacid are cyclo or bicyclo aliphatic acids, for example, decahydro naphthalene dicarboxylic acids, stilbene dicarboxylic acid, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, aliphatic esters, e.g., dialiphatic esters, diaromatic esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, stilbene dicarboxylic acids, naphthalene dicarboxylic acids, and the like, and mixtures comprising at least one of the foregoing dicarboxylic acids.

Examples of these polyvalent carboxylic acids include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxylic acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

In a preferred embodiment the second diacid is selected from the group consisting of, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof. In yet another embodiment the second diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

In one embodiment the polyester may further comprises reactive organic compound comprising at least one functional group. The reactive organic compound comprising at least one functional group is at least one selected from the group consisting of aliphatic or aromatic compounds. The functional group is at least one selected from the group consisting of epoxy, carbodiimide, orthoester, anhydride, oxazoline, imidazoline, isocyanate. In an embodiment the functional group is selected from the group consisting of epoxy, imidazoline, oxazoline.

According to an embodiment, the reactive organic compound comprising at least one functional group may include multifunctional epoxies. In one embodiment the stabilized composition of the present invention may optionally comprise at least one epoxy-functional polymer. One epoxy polymer is an epoxy functional (alkyl)acrylic monomer and at least one non-functional styrenic and/or (alkyl)acrylic monomer. In one embodiment, the epoxy polymer has at least one epoxy-functional (meth)acrylic monomer and at least one non-functional styrenic and/or (meth)acrylic monomer which are characterized by relatively low molecular weights. In another embodiment the epoxy functional polymer may be epoxy-functional styrene (meth)acrylic copolymers produced from monomers of at least one epoxy functional (meth)acrylic monomer and at least one non-functional styrenic and/or (meth)acrylic monomer. As used herein, the term (meth) acrylic includes both acrylic and methacrylic monomers. Non-limiting examples of epoxy-functional (meth)acrylic monomers include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itaconate.

Epoxy functional materials suitable for use as the carboxyl reactive group contain aliphatic or cycloaliphatic epoxy or polyepoxy functionalization. Generally, epoxy functional materials suitable for use herein are derived by the reaction of an epoxidizing agent, such as peracetic acid, and an aliphatic or cycloaliphatic point of unsaturation in a molecule. Other functionalities which will not interfere with an epoxidizing action of the epoxidizing agent may also be present in the molecule, for example, esters, ethers, hydroxy, ketones, halogens, aromatic rings, etc. A well known class of epoxy functionalized materials are glycidyl ethers of aliphatic or cycloaliphatic alcohols or aromatic phenols. The alcohols or phenols may have more than one hydroxyl group. Suitable glycidyl ethers may be produced by the reaction of, for example, monophenols or diphenols described in Formula I such as bisphenol-A with epichlorohydrin. Polymeric aliphatic epoxides might include, for example, copolymers of glycidyl methacrylate or allyl glycidyl ether with methyl methacrylate, styrene, acrylic esters or acrylonitrile.

Specifically, the epoxies that can be employed herein include glycidol, bisphenol-A diglycidyl ether, tetrabromobisphenol-A diglycidyl ether, diglycidyl ester of phthalic acid, diglycidyl ester of hexahydrophthalic acid, epoxidized soybean oil, butadiene diepoxide, tetraphenylethylene epoxide, dicyclopentadiene dioxide, vinylcyclohexene dioxide, bis(3,4-epoxy-6-methylcyclohexylmethyl)adipate, and 3,4-epoxycyclohexylmethyl-3,4-epoxycyclohexane carboxylate (ERL).

According to an embodiment, such additional reactive groups may include reactive oxazoline compounds, which are also known as cyclic imino ether compounds. Such compounds are described in Van Benthem, Rudolfus A. T. et al., U.S. Pat. No. 6, 660,869 or in Nakata, Yoshitomo et al., U.S. Pat. No. 6,100,366. Examples of such compounds are phenylene bisoxazolines (hereinafter also called “PBO”), 1,3-PBO, 1,4-PBO, 1,2-naphthalene bisoxazoline, 1,8-naphthalene bisoxazoline, 1,1 1-dimethyl-1,3-PBO and 1,1 1-dimethyl-1,4-PBO.

In another embodiment, the reactive group can be oligomeric copolymer of vinyl oxazoline and acrylic monomers. Specific examples of preferable oxazoline monomers include 2-vinyl-2-oxazoline, 5-methyl-2-vinyl-2-oxazoline, 4,4-dimethyl-2-vinyl-2-oxazoline, 4,4-dimethyl-2-vinyl-5,5-dihydro-4H-1,3-oxazoline, 2-isopropenyl-2-oxazoline, and 4,4-dimethyl-2-isopropenyl-2-oxazoline. Particularly, 2-isopropenyl-2-oxazoline and 4,4-dimethyl-2-isopropenyl-2-oxazoline are preferable, because they show good copolymerizability. The monomer component may further include other monomers copolymerizable with the cyclic imino ether group containing monomer. Examples of such other monomers include unsaturated alkyl carboxylate monomers, aromatic vinyl monomers, and vinyl cyanide monomers. These other monomers may be used either alone respectively or in combinations with each other. Examples of the unsaturated alkyl carboxylate monomer include methyl(meth)acrylate, ethyl(meth)acrylate, propyl (meth)acrylate, n-butyl(meth)acrylate, iso-butyl(meth)acrylate, t-butyl(meth)acrylate, 2-ethylhexyl(meth)acrylate, n-octyl(meth)acrylate, iso-nonyl(meth)acrylate, dodecyl (meth)acrylate, and stearyl(meth)acrylate, styrene and a-methyl styrene.

In one embodiment the reactive organic compound comprises bisoxazolines for the formula (TI)

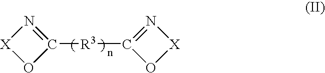

wherein X is a bivalent group, and wherein X gives a 5-membered ring or 6-membered ring and R³ is at least one bivalent group selected from aliphatic, aromatic or cycloaliphatic groups, and n is an integer from 0 to 5. In one embodiment X is at least one selected from the group consisting of a substituted or unsubstituted ethylene group, or substituted or unsubstituted trimethylene group. The substitution on the ethylene or trimethylene group is selected from the group consisting of methyl, ethyl, hexyl, alkylhexyl, nonyl, phenyl, naphthyl, diphenyl, or cyclohexyl groups. In one embodiment, the bisoxazolines is at least one selected from the group consisting of 2,2′-bis(2-oxazoline), 2,2′-bis(4-methyl-2-oxazoline), 2,2′-bis(4-phenyl-2-oxazoline), 2,2′-bis(4-hexyloxazoline), 2,2′-p-phenylenebis(2-oxazoline), 2,2′-m-phenylenebis(2-oxazoline), 2,2′-tetramethylenebis(4,4′-dimethyl-2-oxazoline).

In one embodiment, the reactive organic compound comprising at least one functional group is selected from the group consisting of epoxy and orthoester. In one embodiment the reactive organic compound comprising at least one functional group is of the formula (III)

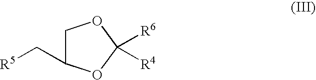

wherein R⁴, R⁵, R⁶ are independently at any occurrence an alkyl, alkoxy, aromatic, aryloxy, hydroxy, or hydrogen, alkoxy or aryloxy or hydroxy. In yet another embodiment the reactive organic compound comprising at least one functional group is of the formula (IV)

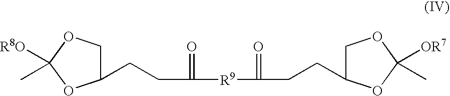

wherein R⁷, R⁸ are independently at each occurrence selected from the group consisting of alkyl, aromatic, hydrogen and R⁹ is an aromatic radical.

According to an embodiment, such additional carboxyl reactive groups may include reactive imidazoline compounds. These imidazoline compounds are preferably 2-imidazolines as described in the references, Synthesis, Vol 12, Page 963 to 965, 1981 and Chemical Review, 54, 593-613 (1954). Typically, the imidazoline compound comprises at least one imidazoline group and not restricted 1,3-phenylene-bisimidazoline, or 1,4-phenylene-bisimidazoline. A typical process to prepare 1,4-phenylene-bisimidazoline includes the condensation of p-benzodinitrile with ethylene diamine.

Typically, the reactive organic compound is present in a range from 0 weight percent and about 25 weight percent based on the total weight of the composition. In another embodiment the reactive organic compound is present in a range of from about 0.05 weight percent and about 1.5 weight percent based on the total weight of the composition.

In one embodiment, the composition of the present further includes additives which do not interfere with the previously mentioned desirable properties but enhance other favorable properties such as anti-oxidants, flame retardants, flow modifiers, impact modifiers, colorants, mold release agents, UV light stabilizers, heat stabilizers, reinforcing materials, colorants, nucleating agents, lubricants, antidrip agents and combinations thereof. Additionally, additives such as antioxidants, minerals such as talc, clay, mica, and other stabilizers including but not limited to UV stabilizers, such as benzotriazole, supplemental reinforcing fillers such as flaked or milled glass, and the like, flame retardants, pigments or combinations thereof may be added to the compositions of the present invention. The additive is present ranging from 0 to 40 weight percent, based on the total weight of the thermoplastic resin.

In yet another embodiment of the present invention, the composition further comprises a filler. The filler is selected from the group consisting of calcium carbonate, mica, kaolin, talc, glass fibers, carbon fibers, carbon nanotubes, magnesium carbonate, sulfates of barium, calcium sulfate, titanium, nano clay, carbon black, silica, hydroxides of aluminum or ammonium or magnesium, zirconia, nanoscale titania, or a combination thereof.

The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIa, VIa and VIII of the Periodic Table), oxides of metals (such as aluminum oxide, titanium oxide, zirconium oxide, titanium dioxide, nanoscale titanium oxide, aluminum trihydrate, vanadium oxide, and magnesium oxide), hydroxides of aluminum or ammonium or magnesium, carbonates of alkali and alkaline earth metals (such as calcium carbonate, barium carbonate, and magnesium carbonate), antimony trioxide, calcium silicate, diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, tungsten carbide, ferrites, molybdenum disulfide, asbestos, cristobalite, aluminosilicates including Vermiculite, Bentonite, montmorillonite, Na-montmorillonite, Ca-montmorillonite, hydrated sodium calcium aluminum magnesium silicate hydroxide, pyrophyllite, magnesium aluminum silicates, lithium aluminum silicates, zirconium silicates, and combinations comprising at least one of the foregoing fillers. Suitable fibrous fillers include glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, and aluminum borate whiskers.

Alternatively, or in addition to a particulate filler, the filler may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

Optionally, the fillers may be surface modified, for example treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve impact, tensile, flexural, and/or dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, chromates, chlorinated paraffins, organosilicon compounds, and reactive cellulosics. The fillers may also be partially or entirely coated with a layer of metallic material to facilitate conductivity, e.g., gold, copper, silver, and the like.

In a preferred embodiment, the filler comprises glass fibers. For compositions ultimately employed for electrical uses, it is preferred to use fibrous glass fibers comprising lime-aluminum borosilicate glass that is relatively soda free, commonly known as “E” glass. However, other glasses are useful where electrical properties are not so important, e.g., the low soda glass commonly known as “C” glass. The glass fibers may be made by standard processes, such as by steam or air blowing, flame blowing and mechanical pulling. Preferred glass fibers for plastic reinforcement may be made by mechanical pulling. The diameter of the glass fibers is generally about 1 to about 50 micrometers, preferably about 1 to about 20 micrometers. Smaller diameter fibers are generally more expensive, and glass fibers having diameters of about 10 to about 20 micrometers presently offer a desirable balance of cost and performance. The glass fibers may be bundled into fibers and the fibers bundled in turn to yarns, ropes or rovings, or woven into mats, and the like, as is required by the particular end use of the composition. In preparing the molding compositions, it is convenient to use the filamentous glass in the form of chopped strands of about one-eighth to about 2 inches long, which usually results in filament lengths between about 0.0005 to about 0.25 inch in the molded compounds. Such glass fibers are normally supplied by the manufacturers with a surface treatment compatible with the polymer component of the composition, such as a siloxane, titanate, or polyurethane sizing, or the like.

When present in the composition, the filler may be used from 0 to about 75 weight percent, based on the total weight of the composition. Within this range, it is preferred to use at least about 20 weight percent of the filler. Also within this range, it is preferred to use up to about 50 weight percent, more preferably up to about 30 weight percent, of the filler.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 1 to 30 percent by weight based on the weight of resin. A preferred range will be from about 5 to 20 percent.

Typically, halogenated aromatic flame-retardants include tetrabromobisphenol A polycarbonate oligomer, polybromophenyl ether, brominated polystyrene, brominated BPA polyepoxide, brominated imides, brominated polycarbonate, poly(haloaryl acrylate), poly(haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame retardants are typically used with a synergist, particularly inorganic antimony compounds. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.1 to 10 by weight based on the weight percent of resin in the final composition. Also, the final composition may contain polytetrafluoroethylene (PTFE) type resins or copolymers used to reduce dripping in flame retardant thermoplastics. Also other halogen-free flame retardants than the mentioned P or N containing compounds can be used, non limiting examples being compounds as Zn-borates, hydroxides or carbonates as Mg- and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5 ′(1,1,3,3-tetramethylbutyl)-,5-chloro-3′,5′-di-tert-butyl-,5-chloro-3′tert-butyl-5 ′methyl-,3′sec-butyl-5 ′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluroethylene). When used, an anti-dripping agent is present in an amount of about 0.02 to about 2 weight percent, and more preferably from about 0.05 to about 1 weight percent, based on the total weight of the composition.

Dyes or pigments may be used to give a background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

In one embodiment, a catalyst may be employed. The catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or titananium compounds; a nitrogen-containing compound such as tetra-alkyl ammonium hydroxides used like the phosphonium analogues, e.g., tetra-alkyl phosphonium hydroxides or acetates. The Lewis acid catalysts and the aforementioned metal oxide or salts can be used simultaneously.

Inorganic catalysts include compounds such as the hydroxides, hydrides, amides, carbonates, phosphates, borates, carboxylates etc., of alkali metals such as sodium, potassium, lithium, cesium, etc., and of alkali earth metals such as calcium, magnesium, barium, etc., can be cited such as examples of alkali or alkaline earth metal compounds. Typical examples include sodium stearate, sodium carbonate, sodium acetate, sodium bicarbonate, sodium benzoate, sodium caproate, or potassium oleate.

In one embodiment, the catalyst is selected from one of phosphonium salts or ammonium salts (not being based on any metal ion) for improved hydrolytic stability properties. In another embodiment of the invention, the catalyst is selected from one of: a sodium stearate, a sodium benzoate, a sodium acetate, and a tetrabutyl phosphonium acetate. In yet another embodiment of the present invention the catalysts is selected independently from a group of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tin oxide, antimony trioxide, sodium polystyrenesulfonate, titanium isoproxide and tetraammoniumhydrogensulfate.and mixtures thereof. In an alternative embodiment, the catalyst may be a compound of the form M(OR¹⁰)_{q} where M is an alkaline earth or alkali metal, such as sodium, potassium, lithium, cesium, etc., and of alkali earth metals such as calcium, magnesium, barium, etc. metals and transitional metals like aluminium, magnesium, manganese, zinc, titanium, nickel and R¹⁰ can be an aliphatic or aromatic organic compound such as methyl, ethyl, propyl, phenyl etc and q is the valence of the metal corresponding to the compound.

In one embodiment, the catalysts include, but are not limited to metal salts and chelates of Ti, Zn, Ge, Ga, Sn, Ca, Li and Sb. Other known catalysts may also be used for this step-growth polymerization. The choice of catalyst being determined by the nature of the reactants. In one embodiment of the present invention, the reaction mixture comprises at least two catalysts. The various catalysts for use herein are very well known in the art and are too numerous to mention individually herein. A few examples of the catalysts which may be employed in the above process include but are not limited to titanium alkoxides. such as tetramethyl, tetraethyl, tetra(n-propyl), tetraisopropyl and tetrabutyl titanates; dialkyl tin compounds, such as di-(n-butyl) tin dilaurate. di-(n-butyl) tin oxide and di-(n-butyl) tin diacetate; acetate salts and sulfate salts of metals, such as magnesium, calcium, germanium, zinc, antimony, etc. In one embodiment, the catalyst is titanium alkoxides. The catalyst level is employed in an effective amount to enable the copolymer formation and is not critical and is dependent on the catalyst that is used. Generally the catalyst is used in concentration ranges of about 5 to about 2000 ppm, preferably about is less than about 1000 ppm and most preferably about 20 to about 1000 ppm.

In another embodiment, a catalyst quencher may optionally be added to the reaction mixture. The choice of the quencher is essential to avoid color formation and loss of clarity of the thermoplastic composition. In one embodiment, the catalyst quenchers are phosphorus containing derivatives, examples include but are not limited to diphosphites, phosphonates, metaphosphoric acid, arylphosphinic and arylphosphonic acids, polyols, carboxylic acid derivatives and combinations thereof. The amount of the quencher added to the thermoplastic composition is an amount that is effective to stabilize the thermoplastic composition. In one embodiment, the amount is at least about 0.001 weight percent, preferably at least about 0.01 weight percent based on the total amounts of said thermoplastic resin compositions. The amount of quencher used is not more than the amount effective to stabilize the composition in order not to deleteriously affect the advantageous properties of said composition.

The reaction can be conducted in presence of minimal amount of a solvent or in neat conditions without the solvent. Minimal amount hereinafter would mean not greater than about 10 percent. The organic solvent used in the above process according to the invention should be capable of dissolving the polyester to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone, N— acetyl-2-pyrrolidone, N,N′-dimethyl formamide, N,N′-dimethyl acetamide, N,N′-diethyl acetamide, N,N′-dimethyl propionic acid amide, N,N′-diethyl propionic acid amide, tetramethyl urea, tetraethyl urea, hexamethylphosphor triamide, N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment, the polyesters in one embodiment have an intrinsic viscosity (as measured in 60:40 solvent mixture of phenol/tetrachloroethane at 25° C.) ranging from about 0.1 to about 1.5 deciliters per gram. In another embodiment, the polyesters may be branched or unbranched and having a weight average molecular weight of at least greater than 5000, preferably from about 5000 to about 150000 as measured by gel permeation chromatography using 95:5 weight percent of chloroform and hexafluoroisopropanol mixture.

The polyester comprises different end groups. The end groups of the polyester is selected from the group consisting of acid end groups, hydroxyl end groups, vinyl end groups, ester end groups. In one embodiment of the present invention, the polyester has at least greater than about 75 percent acid end groups relative to the total number of end groups. In another embodiment of the present invention, the polyester has from about 75 percent to about 100 percent acid end groups relative to the total number of end groups. In yet another embodiment of the present invention, the polyester has at least about 10 percent hydroxyl end groups relative to the total number of end groups. In another embodiment of the present invention, the polyester has from about 0 percent to about 15 percent hydroxyl end groups relative to the total number of end groups. In one embodiment of the present invention, the polyester has at least less than about 10 percent vinyl end groups relative to the total number of end groups, and preferably less than about 5 percent vinyl end groups relative to the total number of end groups. In yet another embodiment, the polyester has an acid number in the range from about 30 to about 800 milli mole per kg at a number average molecular weight in the range from about 2000 to about 70000 and a hydroxyl number in the range from about 30 to about 100 milli mole per kg at a number average molecular weight in the range from about 2000 to about 70000.

In one embodiment of the present invention, the polyesters are prepared by melt process. The process may be a continuous polymerization process wherein the said reaction is conducted in a continuous mode in a train of reactors of at least two in series or parallel. In an alternate embodiment, the process may be a batch polymerization process wherein the reaction is conducted in a batch mode in a single vessel or in multiple vessels and the reaction can be conducted in two or more stages depending on the number of reactors and the process conditions. In an alternate embodiment, the process can be carried out in a semi-continuous polymerization process where the reaction is carried out in a batch mode and the additives are added continuously. Alternatively, the reaction is conducted in a continuous mode where the polymer formed is removed continuously and the reactants or additives are added in a batch process. In an alternate embodiment, the product from at least one of the reactors can be recycled back into the same reactor intermittently by “pump around” to improve the mass transfer and kinetics of reaction. Alternatively, the reactants and the additives are stirred in the reactors with a speed of about 25 revolutions per minute (here in after “rpm”) to about 2500 rpm.

In one embodiment of the present invention, the process may be carried out in an inert atmosphere. The inert atmosphere may be either nitrogen or argon or carbon dioxide. The heating of the various ingredients may be carried out in a temperature between about 90° C. and about 230° C. and at a pressure of about 300 kPa to about 80 kPa.

In one embodiment, the ingredients are heated to a temperature between 125° C. and about 300° C. and at a pressure of about 100 mm to 900 mm of Hg to form the first mixture. The first mixture is heated to a temperature between about 175° C. and about 250° C. to form a molten mixture. In one embodiment, the process is carried out at a pressure of about 500 mm of Hg.

In one embodiment, the ratio of carboxyl groups of the second diacid to hydroxyl groups of the hydroxyl terminated polyester is in the range from about 0.5 to about 1. In one embodiment, the amount of unreacted second diacid hereinafter also known as residual second diacid is at least less than about 1000 parts per million. In yet another embodiment, the amount of residual second diacid is in the range from about 5 to about 750 parts per million.

In one embodiment, the reaction is then carried out under vacuum of about 500 mm of Hg while the reaction occurs and polyester of desired molecular weight is built. In one embodiment, the polyester is recovered by isolating the polymer followed by grinding or by extruding the hot polymer melt, cooling and pelletizing.

In one embodiment, the reactive organic compound is added along with the diol and diacid to form the reaction mixture. In another embodiment, the reactive organic compound is added at various stages in the process. In yet another embodiment, a part of the reactive organic compound is added to the reaction mixture and a part is added to the first mixture. In an alternate embodiment, a part of the reactive organic compound is added to the reaction mixture and a part is added to the molten mixture.

In one embodiment, the polyester composition may be made by conventional blending techniques. The production of the compositions may utilize any of the blending operations known for the blending of thermoplastics, for example blending in a kneading machine such as a Banbury mixer or an extruder. To prepare the composition, the components may be mixed by any known methods. Typically, there are two distinct mixing steps: a premixing step and a melt-mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C.

The molten mixture of the polyester may be obtained in particulate form, for example, by pelletizing or grinding the composition. The composition of the present invention can be molded into useful articles by a variety of means by many different processes to provide useful molded products such as injection, extrusion, rotation, foam molding calender molding and blow molding and thermoforming, compaction, melt spinning form articles. Non-limiting examples of the various articles that could be made from the thermoplastic composition of the present invention include electrical connectors, electrical devices, computers, building and construction, outdoor equipment. The articles made from the composition of the present invention may be used widely in house ware objects such as food containers and bowls, home appliances, as well as films, electrical connectors, electrical devices, computers, building and construction, outdoor equipment, trucks and automobiles. In one embodiment, the polyester may be blended with other conventional polymers.

In one embodiment, the invention provides previously unavailable advantages of a polyester composition with high percent of acid end groups in addition to having higher molecular weight and that is devoid of unwanted end groups such as double bond or vinyl groups which cause instability. The high percent of acid end groups react more readily with carboxy reactive functional group such as epoxy providing a handle to functionalize polyesters. The process also helps overcoming the degradation problems observed using diacids at high temperature and atmospheric pressure.

The invention is described further in the following illlustrative examples, in which all parts are by weight unless otherwise indicated.

### EXAMPLES

### Examples 1-4 and Comparative Example 1-2

### Materials

The materials employed for example 1-4 and comparative example 1-2 are shown in Table 1.

TABLE 1
Abbrerviation

| | |
|---|---|
| TPA | Terephthalic acid from Sigma Aldrich |
| NaSt | Sodium stearate from SD Finechem |
| PBT | Polybutylene terephthalate |
| PBT 1 | Polybutylene terephthalate oligomer from GE Plastics |

### Procedures/Techniques

### Examples 1-4

10 g PBT-loligomer (of hydroxyl value around 330 meq/Kg) was added to a 3-necked round bottom flask fitted with an overhead stirrer and fitted with a vacuum setup. The RB was placed in an oil bath that was electrically preheated to around 230° C. About 0.23 gram of terephthalic acid (85% of stoichiometric amount) was added to the round bottom flask and the contents were allowed to react for a period of about 4 hours. The resulting material was analyzed for concentration of hydroxyl, vinyl and ester end groups by ¹H-NMR spectroscopy. The carboxylic acid end group concentration was determined by potentiometric titration with sodium hydroxide (NaOH). The number average molecular weight (Mn) was determined from the total end group concentration. Unreacted terephthalic acid in the system was determined by Shimadzu High Performance Liquid Chromatogtraphy. The experiments were carried out at 230° C. at a pressure of 700 mbar, 500 mbar and 100 mbar pressure and at 240° C. and 700 mbar pressure (EXAMPES Ex.1-Ex.4).

### Comparative Exaples 1 and 2

Experiments were carried out in a similar way as mentioned in the section above except that here the vacuum set up was replaced with a nitrogen inlet. The experiment was carried out at temperatures of 230 and 240° C. (CEx. 1 and CEx.2).

### RESULTS AND DISCUSSION

The Table 2 describes the various process conditions and the end group analysis results for the Examples 1-4 and Comparative Example 1 and 2.

TABLE 2

| | CEx. 1 | | Ex. 1 | | Ex. 2 | | Ex. 3 | | CEx. 2 | | Ex. 4 | |
|---|---|---|---|---|---|---|---|---|---|---|---|---|
| Temperature (° C.) | 230 | | 230 | | 230 | | 230 | | 240 | | 240 | |
| Pressure (mbar) | 1 atmosphere | | 700 | | 500 | | 100 | | ? | | 700 | |
| | meq/kg | % | meq/kg | % | meq/kg | % | meq/kg | % | meq/kg | % | meq/kg | % |
| Carboxylic Endgroup | 280.0 | 69.3 | 218.0 | 85.4 | 236.0 | 88.4 | 235.0 | 86.1 | 310.0 | 75.4 | 205.0 | 73.4 |
| Hydroxyl endgroup | 80.0 | 19.8 | 9.0 | 3.6 | 0.0 | 0.0 | 0.0 | 0.0 | 10.0 | 2.4 | 0.0 | 0.0 |
| Vinyl endgroup | 4.0 | 1.0 | 0.0 | 0.0 | 0.0 | 0.0 | 5.0 | 1.8 | 70.0 | 17.1 | 34.0 | 12.2 |
| ester endgroup | 40.0 | 9.9 | 28.0 | 11.0 | 31.0 | 11.6 | 33.0 | 12.1 | 21.0 | 5.1 | 40.0 | 14.4 |

| | | | | | | |
|---|---|---|---|---|---|---|
| Mn (g/mol) | 4954.0 | 7843.0 | 7490.0 | 7326.0 | 4866.0 | 7168 |
| Residual second acid | 3312 | 598 | 460 | 483 | 2346 | 414 |
| (ppm) | | | | | | |

From Table 2 it may be observed that when the reactions are carried out under vacuum the polyester composition obtained has a higher percent carboxylic acid end groups, with lower percent of unreacted hydroxyl end groups in addition to higher molecular weight Mn and lower amount of residual acid.

### Examples 5-6 and Comparative Example 3-5

The examples 5-6 and comparative examples 3-5 show that the acid enhanced polybutylene terephathalate show good build up in molecular weight and reduction in gloss while retaining the mechanical properties.

### Materials

Table 3 provides a description of the polybutylene terephthalate compositions with their end groups.

TABLE 3

| | PBT 1 | | PBT HA-1* | | PBT HA-2* | |
|---|---|---|---|---|---|---|
| | meq/kg | % | meq/kg | % | meq/kg | % |
| Carboxylic Endgroup | 5 | 1.2 | 360 | 69.4 | 356 | 81.8 |
| Hydroxyl endgroup | 333 | 81.8 | 45 | 8.7 | 51 | 11.7 |
| Vinyl endgroup | 0 | 0 | 101 | 19.5 | 28 | 6.4 |
| Ester endgroup | 69 | 16.9 | 13 | 2.5 | 0 | 0.0 |

| | | | |
|---|---|---|---|
| Mn(absolute) | 4914 | 3853 | 4598 |

*PBT HA-1 and PBT HA-2 are acid enhanced polybutylene terephthalate

### Examples 5 and Comaparative Example 3

### Procedures/Techniques

### Example 5

Chain extension experiments were done with acid enhanced oligomer PBT HA-2 with Araldite GT6071 (a bifunctional BPA epoxy(Molecular weight 900g/mol) from Ciba Speciality Chemicals). The chain extension was carried out in a Haake 600p internal mixer for about 20 minutes at around 250° C. The mole ratio of PBT carboxylic acid end groups to the epoxy groups of Araldite GT 6071 was about 1:1 at the beginning of the reaction. Samples were withdrawn at 0, 5, 10 and 20 minutes of heating and their molecular weight was determined using Shimadzu Gel Permeation Chromatography.

### Comparative Example 3

The experiment was carried out in a manner similar to that described for Example 5, except that instead of PBT HA-2, the polybutylene terephthale employed was PBT HA-1.

### RESULTS AND DISCUSSION

The results are tabulated in Table 4 from which it may be seen that Ex.5 (PBT HA-2) with 80% carboxylic acid end groups shows about 116% increase in molecular weight (Mn) as against 72% with CEx.3 (PBT HA-1) with 70% acid end groups.

TABLE 4

| | | CEx. 3 | | Ex. 5 | |
|---|---|---|---|---|---|
| | | | % Change | | % Change |
| Mn @ 0 min | g/mol | 7600 | 0.0 | 8600 | 0.0 |
| Mn @ 5 min | g/mol | 8100 | 6.6 | 9400 | 9.3 |
| Mn @ 10 min | g/mol | 9600 | 26.3 | 11600 | 34.9 |
| Mn @ 20 min | g/mol | 13100 | 72.4 | 18600 | 116.3 |

### Example 6 and Comparative Examples 4-5

### Procedures/Techniques

### Example 6

The experiment was carried out by adding a portion of acid enhanced oligomer PBT HA-2 to PBT-1, glass filler (Chopped E Glass fiber NEG T120 from Nippon Glass company) and Silquest Y (Beta-(3,4 epoxy cyclohexyl)-ethyltrimethoxy silane from GE Advanced Materials) into a ZSK 25 co-rotating twin-screw extruder from WERNER and PFLEIDERER Co-extruder, and mixed at a barrel temperature of about 240° C. to 275° C., maintaining a torque at 80 percent, and a screw rotation rate of 300 rotations per minute (rpm). The extrudate was then fed into a high-speed pelletizer. The resulting pellets were dried for at least 4 hours at 80° C. before injection molding into mold suitable for the formation of ASTM/ISO test specimens. The tensile elongation, tensile modulus, tensile strength yield, unnotched Izod impact strength, and gloss were determined in accordance with the above ISO methods. Tensile Modulus (Mpa), tensile strength (Mpa) and elongation at break(%) were determined in accordance with ISO 527 at room temperature, using a rate of pull of 1 mm/minute until 1% strain followed by 5 mm/minute until the sample breaks. Tensile properties were tested according to ISO 527 on 150×10×4×mm (length×wide×thickness) injection molded bars at 23° C. with a crosshead speed of 5 mm/min. The Izod unnotched impact was measured at 23° C. with a pendulum of 5.5 Joule on 80×10×4 mm (length×wide×thickness) impact bars according to ISO 180U method.

### Comparative Example 4 and 5

The procedure described above was employed for comparative 4 and 5 in the absence of the acid enhanced PBT HA-2 being added to the formulation described in Table 5. RESULTS AND DISCUSSION

TABLE 5

| | | Cx. 4 | Cx. 5 | Ex. 6 |
|---|---|---|---|---|
| PBT-1 | Wt % | 69.85 | 68.85 | 48.85 |
| PBT HA-2 | Wt % | | | 20.00 |
| Glass Fiber | Wt % | 30.00 | 30.00 | 30.00 |
| Irganox 1010 | Wt % | 0.15 | 0.15 | 0.15 |
| Silquest Y 15589 | Wt % | 0.00 | 1.00 | 1.00 |
| Tensile Modulus | GPa | 9.26 | 9.92 | 11.07 |
| Tensle Strength | MPa | 128.17 | 141.30 | 139.90 |
| Elongation at break | % | 3.90 | 4.14 | 3.37 |
| Unnotched Impact | kJ/m2 | 41.2 | 51.6 | 44.3 |
| Gloss 20° | | 12.4 | 4.9 | 3.7 |
| Gloss 60° | | 28.4 | 14.3 | 12.3 |

It may be observed from Table 5 that addition of 20 wt % PBT HA-2 to Glass filled PBT (Ex.6) leads to a reduction in gloss over a parallel composition not containing PBT HIA-2 (CEx.4 and CEx.5), while retaining the mechanical properties like tensile modulus and impact strength.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A composition of matter comprising an acid terminated polyester composition containing:
a. a polyester derived from at least one diol selected from the group consisting of ethylene glycol; propylene glycol, butanediol, xylene glycol, and a first diacid component; and
b. a second diacid component; and
wherein the composition contains a residue of the second diacid component that is at least less than about 1000 parts per million.

2. The composition of claim 1, wherein the first diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

3. The composition of claim 1, wherein the second diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

4. The composition of claim 1, wherein the polyester comprises end groups, and wherein the polyester contains at least about 75 percent acid end groups relative to the total number of the end groups.

5. The composition of claim 1, wherein the polyester comprises at least about 10 percent of hydroxyl end groups relative to the total number of end groups.

6. The composition of claim 1, wherein the polyester comprises at least about 10 percent of an vinyl end groups relative to the total number of end groups.

7. The composition of claim 1, wherein the polyester has an acid number ranging from about 30 to about 800 milli mole per kg at a number average molecular weight ranging from about 2000 to about 70000.

8. The composition of claim 1, wherein the polyester has a hydroxyl number ranging from about 30 to about 100 milli mole per kg at a number average molecular weight in the range from about 2000 to about 70000.

9. The composition of claim 1, further comprises a reactive organic compound having at least one functional group.

10. The composition of claim 9, wherein the reactive organic compound comprising at least one functional group is at least one selected from the group consisting of epoxy, carbodiimide, orthoesters, anhydrides, oxazoline, and imidazolines.

11. The composition of claim 9, wherein the reactive organic compound is present in an amount ranging from about 0.5 to about 1.5 mol percent, based on the total mol percent of acid end groups.

12. The composition of claim 1, wherein the composition further comprises an additive.

13. The composition of claim 12, wherein the additive is selected from the group consisting of anti-oxidants, flame retardants, flow modifiers, impact modifiers, colorants, mold release agents, UV light stabilizers, heat stabilizers, lubricants, antidrip agents and combinations thereof.

14. The composition of claim 12, wherein the additive is present ranging from 0 to 40 weight percent, based on the total weight of the thermoplastic resin.

15. The composition of claim 1, wherein the composition further comprises a filler.

16. The composition of claim 15 wherein the filler is selected from the group consisting of calcium carbonate, mica, kaolin, talc, glass fibers, carbon fibers, carbon nanotubes, magnesium carbonate, sulfates of barium, calcium sulfate, titanium, nano clay, carbon black, silica, hydroxides of aluminum or ammonium or magnesium, zirconia, nanoscale titania, or a combination thereof.

17. An article molded from the composition of claim 1.

18. A process comprising:
i. mixing a hydroxyl terminated polyester having end groups wherein the hydroxyl terminated polyester is derived from at least one diol selected from the group consisting of ethylene glycol; propylene glycol, butanediol, xylene glycol, and a first diacid and comprising at least about 10 percent of hydroxyl end groups relative to the total number of end groups and a second diacid to form a first mixture;
ii. heating the first mixture at a temperature in the range from about 170 to about 280° C., wherein the heating is carried out at a pressure in the range from about 100 milli bar to about 900 mili bar to form a composition of matter comprising an acid terminated polyester composition containing
a. a polyester derived from at least one diol selected from the group consisting of ethylene glycol; propylene glycol, butanediol, xylene glycol, and a first diacid component;
b. a second diacid component; and
wherein the composition contains a residual of the second diacid component that is at least less than about 1000 parts per million.

19. The process of claim 18, wherein the second diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

20. The process of claim 18, wherein the ratio of carboxyl groups of the second diacid to hydroxyl groups from the hydroxy terminated polyester is in the range from about 0.5 to about 1.

21. The process of claim 18, wherein the process is carried out in presence of a catalyst.

22. The process of claim 21, wherein the catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, coordination complexes of the foregoing and combinations thereof.

23. The process of claim 18, wherein the process is carried out in presence of a minimal amount of a solvent.

24. A composition of matter comprising an acid terminated polyester composition containing:
a. a polyester derived from at least one diol selected from the group consisting of ethylene glycol; propylene glycol, butanediol, xylene glycol, and a first diacid component; and
b. a second diacid component; and
wherein the amount of a residual second diacid is at least less than about 1000 parts per million; and wherein the polyester comprises end groups and has greater than about 80 percent acid end groups relative to the total number of end groups, and less than about 10 percent of a vinyl terminated polyester relative to the total number of end groups.
